(19) United States
(12) Patent Application Publication
(10) Pub. No.: US 2026/0003686 A1
(43) Pub. Date: Jan. 1, 2026

(54) SYSTEMS, APPARATUSES, METHODS, AND COMPUTER PROGRAM PRODUCTS FOR IMPROVED PROCESS MONITORING

(71) Applicant: Honeywell International Inc., Charlotte, NC (US)

(72) Inventors: Rajeeva Naduthota Manjunatha, Bangalore (IN); Sriram Hallihole, Bengaluru (IN); Ranjeet Das, Bangalore (IN); Shivanky Jaiswal, Bengaluru (IN)

(21) Appl. No.: 18/758,477

(22) Filed: Jun. 28, 2024

(51) Int. Cl. G06F 9/50

(52) U.S. Cl. CPC G06F 9/5027

(57) ABSTRACT

Embodiments of the present disclosure provide improved process monitoring. Process data associated with a controller may be received. The process data may comprise a plurality of data samples. One or more process data evaluation iterations may be performed to generate one or more process data subsets by removing one or more portions of the process data that is associated with at least one asset condition of one or more asset conditions. One or more asset performance scores may be generated based on the one or more process data subsets. A user interface comprising the one or more asset performance scores may be caused to be rendered on a user device.

### TECHNICAL FIELD

The present disclosure relates, generally, to systems, apparatuses, methods, and computer program products for improved process monitoring. Example embodiments evaluate the effective utilization of advanced process control (APC) controllers and/or plant wide optimizers (PWO).

### BACKGROUND

In various contexts, processing facilities are often managed using process control and automation systems that include APC controllers and/or PWO for process monitoring. Various key performance indicator(s) may be leveraged to evaluate the performance of the APC controllers and/or PWO. Applicant has discovered problems with current implementations of evaluating the performance of APC controllers and/or PWO. Through applied effort, ingenuity, and innovation, Applicant has solved many of these identified problems by developing solutions embodied in the present disclosure, which are described in detail below.

### BRIEF SUMMARY

In accordance with one aspect of the present disclosure, a computer-implemented method for asset performance predictions is provided. The computer-implemented method is executable using any of a myriad of computing device(s) and/or combinations of hardware, software, and/or firmware. In some example embodiments, an example computer-implemented method includes receiving, by one or more processors, process data associated with a controller, the process data comprising a plurality of data samples; performing, by the one or more processors, one or more process data evaluation iterations to generate one or more process data subsets by removing one or more portions of the process data that is associated with at least one asset condition of one or more asset conditions; generating, by the one or more processors and based on the one or more process data subsets, one or more asset performance scores; and causing, by the one or more processors, rendering of a user interface comprising the one or more asset performance scores on a user device.

In some embodiments, the one or more asset conditions comprise a controller maintenance mode condition associated with the controller and a controller off mode condition associated with the controller.

In some embodiments, the one or more process data evaluation iterations comprises a set of one or more controller-level process data evaluation iterations, where the set of one or more controller-level process data evaluation iterations comprise (i) a first controller-level process data evaluation iteration performed based on the controller maintenance mode condition and (ii) second controller-level process data evaluation iteration performed based on the controller off mode condition.

In some embodiments, the one or more process data subsets comprises a first process data subset that is generated by performing the first controller-level process data evaluation iteration, wherein performing the first controller-level process data evaluation iteration comprises: for each data sample associated with the process data: determining whether the data sample is associated with a controller maintenance mode condition based on one or more user-defined models; and in response to determining that the process data is associated with a controller maintenance mode condition, removing the data sample from the process data.

In some embodiments, the one or more asset performance scores comprises a percent-not-required score corresponding to a percent-not-required KPI for the controller, wherein the percent-not-required score is generated at least in part by comparing a number of data samples removed from the process data to the number of data samples associated with the process data.

In some embodiments, the one or more process data subsets comprises a second process data subset that is generated by performing the second controller-level process data evaluation iteration of the set of one or more controller-level process data evaluation iterations, wherein performing the second controller-level process data evaluation iteration comprises: for each data sample associated with the first process data subset: determining whether the data sample is associated with a controller off mode condition; and in response to determining that the first process data subset is associated with a controller off mode condition, removing the data sample from the first process data subset.

In some embodiments, the one or more asset performance scores comprises one or more of a service factor score corresponding to a service factor KPI for the controller or an effective service factor score corresponding to an effective service factor KPI for the controller, wherein the service factor score or the effective service factor score is generated at least in part by comparing a number of data samples removed from the first process data subset to the number of data samples associated with the first process data subset.

In some embodiments, the one or more asset conditions further comprise one or more asset variable maintenance mode conditions and one or more asset variable off mode conditions.

In some embodiments, the one or more process data evaluation iterations comprises a set of one or more variable-level process data evaluation iterations, where the set of one or more variable-level process data evaluation iterations comprise (ii) a first variable-level process data evaluation iteration performed based on the one or more asset variable maintenance mode conditions and (ii) second variable-level process data evaluation iteration performed based on the one or more asset variable off mode conditions.

In some embodiments, the one or more process data subsets comprises a third process data subset that is generated by performing the first variable-level process data evaluation iteration, wherein performing the first variable-level process data evaluation iteration comprises: for each data sample associated with the second process data subset: determining whether the data sample is associated with at least one of the one or more asset variable maintenance mode conditions; and in response to determining that the second process data subset is associated with at least one of the one or more asset variable maintenance mode conditions, removing the data sample from the second process data subset.

In some embodiments, the one or more asset performance scores comprises a percent-not-required score corresponding to a percent-not-required KPI for the controller, wherein the percent-not-required score is generated by comparing a number of data samples associated with the third process data subset to the number of data samples associated with the second process data subset.

In some embodiments, the one or more process data subsets comprises a fourth process data subset that is generated by performing a second variable-level process data evaluation iteration of the set of one or more variable-level process data evaluation iterations, wherein performing the second variable-level process data evaluation iteration comprises: for each data sample associated with the third process data subset: determining whether the data sample is associated with at least one of the one or more asset variable off mode conditions; and in response to determining that the fourth process data subset is associated with at least one of the one or more asset variable off mode conditions, removing the data sample from the third process data subset.

In some embodiments, the one or more asset performance scores comprises a service factor score corresponding to a service factor KPI for the controller, wherein the service factor score is generated by comparing a number of data samples associated with the fourth process data subset to the number of data samples associated with the third process data subset.

In accordance with another aspect of the present disclosure, an apparatus for asset performance predictions is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product for asset performance predictions is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1A illustrates a block diagram of an example system architecture in which embodiments of the present disclosure may operate.

FIG. 1B illustrates a block diagram of an example process control and automation system in accordance with at least one example embodiment of the present disclosure.

FIG. 2 illustrates a block diagram of an example apparatus in accordance with at least one example embodiment of the present disclosure.

FIG. 3A illustrates a data flow diagram showing example data structures for asset performance predictions in accordance with at least one example embodiment of the present disclosure.

FIG. 3B illustrates a visualization of process data evaluation iterations at a controller level in accordance with at least one example embodiment of the present disclosure.

FIG. 3C illustrates a visualization of process data evaluation iterations at a variable level in accordance with at least one example embodiment of the present disclosure.

FIGS. 4A-4B each illustrate an example user interface in accordance with at least one example embodiment of the present disclosure.

FIG. 5 illustrates flowchart including operations of an example process for asset performance predictions in accordance with at least one example embodiment of the present disclosure.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein, rather, these embodiments are provided so that this disclosure will satisfy applicable legal requirements.

The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### OVERVIEW AND TECHNICAL IMPROVEMENTS

Various embodiments of the present disclosure are generally directed to systems, apparatuses, methods, and computer program products for improved process monitoring. Example embodiments disclosed herein address technical challenges associated with effective utilization of APC controllers and/or PWO controllers (e.g., APC/PWO controllers) in process control and automation systems for monitoring processes associated with an industrial plant.

While running an APC controller (also referred to herein, interchangeably, as “controller”) or PWO, the plant operator may need to drop (e.g., not use) some control variables (CV), manipulated variables (MV), and/or disturbance variables (DV) and/or or turn off the APC controller itself due to, for example, some process conditions. Often, this is done intentionally by the operator as these assets (e.g., APC controller, CV, MV, DV, and/or the like) may not be required for the current process or in some cases, the asset may be a redundant asset (e.g., only used when a primary asset is not functional as intended). Categorizing all these scenarios to a common bucket as “controller offline” or CV/MV/DV dropped may not be accurate and, in turn, may affect the advance process control KPIs and/or PWO KPIs. Accordingly, a need exists for automatically identifying reason(s) for non-availability (e.g., off-line status) of a controller, CV, MV, and/or DV during a particular time period and generating actionable insights to optimize the monitored processes.

Example embodiments of the present disclosure provide for improved process performance monitoring with respect to an industrial plant (also referred to herein, interchangeably, as process plant) by evaluating the effective utilization of APC controllers, identifying “not required” duration of APC controllers and/or other assets, measuring “not required” duration of APC controllers and/or other assets, and/or identifying the reason(s) for non-availability of an asset during a particular time period. In this regard, example embodiments automatically identify and categorize data associated with APC controllers, PWO, CVs, MVs, and/or DVs as not required for analysis (e.g., including KPI calculations).

Example embodiments, automatically identify when an APC controller, PWO, CV, MV, DV, and/or other assets is active (e.g., in an ON state) and utilize only those data corresponding to when an asset is active for KPI calculations (e.g., APC controller KPI calculations and/or PWO KPI calculations). In this regard, example embodiments accurately categorize data as not required, and exclude those data from calculation of APC controller KPIs and/or PWO KPIs.

Example embodiments, leverage specially-configured model(s) (which, in some embodiments, may be user defined) to continuously evaluate process data (e.g., data output by or associated with APC controllers). In example embodiments, the model(s) may be configured to generate and output time series data which provides details about whether a particular data sample should be considered for APC controller KPI calculation and/or PWO KPI calculation. In this regard, example embodiments provide real-time insights into APC controller utilization and/or PWO utilization and allows a user to customize how certain portions of the process data are used for calculating different KPI’s.

Example embodiments may be configured to determine a percentage-not-required KPI that indicates the amount of time an APC controller, CV, MV, and or DV is not available; identify when an APC controller, CV, MV, and/or DV is active (e.g., in an ON state); and utilize these information for KPI calculations. Moreover embodiments of the present disclosure may provide for rolling up percentage-not-required KPI and/or other KPI to enterprise level by combining data from different APC controllers and/or PWO.

Accordingly, example embodiments improve effective utilization of APC controllers and/or PWO by generating accurate APC controller KPIs and/or PWO KPIs, which are leveraged to control and/or automate the monitored processes on an industrial plant. This, in turn, allows for improved process monitoring and optimization. Accordingly, embodiments of the present disclosure improve at least the technical field of industrial process monitoring and improves process control and automatons systems.

### DEFINITIONS

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

### EXAMPLE SYSTEMS AND APPARATUSES OF THE DISCLOSURE

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

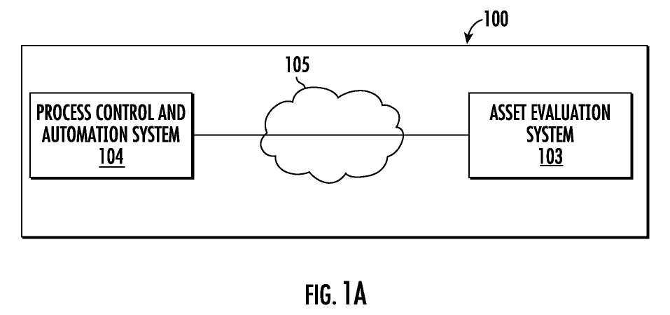

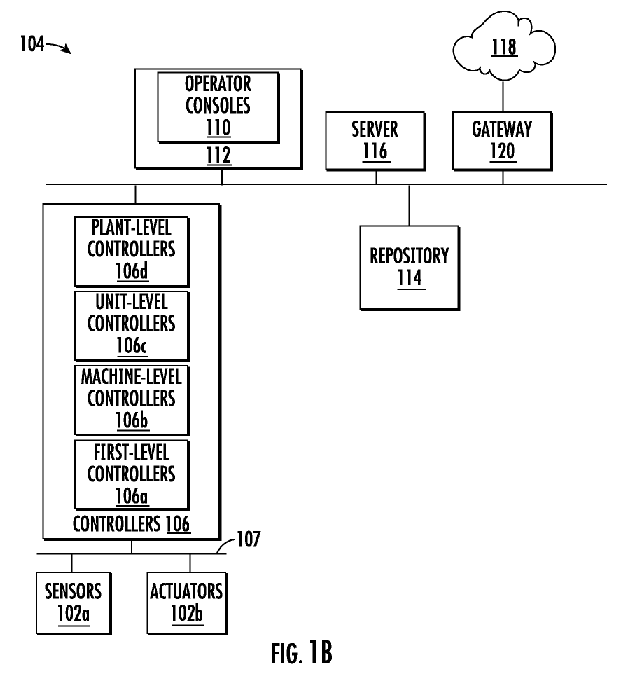

In this regard, FIG. 1 provides an example overview of a system architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG.1 are shown as discrete, separate elements, other configurations may be used in connection with the methods, apparatuses, computer readable media, and computer programs described herein, including configurations that combine, omit, separate, and/or add aspects and/or components. The example system architecture 100 may be used in a plurality of domains and not limited to any specific application as disclosed herewith. In particular, while some example embodiments are described herein with reference to industrial plant domain, the example system architecture 100 may be used in a plurality of domains and limited to any specific application as disclosed herein. The plurality of domains may include healthcare, industrial, manufacturing, education, retail, to name a few.

As illustrated, the system architecture 100 includes a process control and automation system 104 in communication with an asset evaluation system 103. In some embodiments, the process control and automation system 104 communicates with the asset evaluation system 103 over one or more communications network(s), for example a communications network 105.

It should be appreciated that the communications network 105 in some embodiments is embodied in any of a myriad of network configurations. In some embodiments, the communications network 105 embodies a public network (e.g., the Internet). In some embodiments, the communications network 105 embodies a private network (e.g., an internal localized, or closed-off network between particular devices). In some other embodiments, the communications network 105 embodies a hybrid network (e.g., a network enabling internal communications between particular connected devices and external communications with other devices). The communications network 105 in some embodiments includes one or more base station(s), relay(s), router(s), switch(es), cell tower(s), communications cable(s) and/or associated routing station(s), and/or the like. In some embodiments, the communications network 105 includes one or more user-controlled computing device(s) (e.g., a user owned router and/or modem) and/or one or more external utility devices (e.g., Internet service provider communication tower(s) and/or other device(s)).

Each of the components of the system architecture 100 may be communicatively coupled to transmit data to and/or receive data from one another over the same or different wireless and/or wired networks embodying the communications network 105. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 105, the various embodiments are not limited to this architecture. In other embodiments, one or more computing entities share one or more components, hardware, and/or the like, or otherwise are embodied by a single computing device such that connection(s) between the computing entities are over the communications network 105 are altered and/or rendered unnecessary. For example, in some embodiments, the process control and automation system 104 includes some or all of the asset evaluation system 103, such that an external communications network 105 is not required.

In some embodiments, the process control and automation system 104 and the asset evaluation system 103 are embodied in an on-premises system within or associated with a processing plant. In some such embodiments, the process control and automation system 104 and the asset evaluation system 103 are communicatively coupled via at least one wired connection. Alternatively or additionally, in some embodiments, the process control and automation system 104 embodies or includes the asset evaluation system 103, for example as a software component of a single enterprise terminal.

The process control and automation system 104 includes any number of computing device(s), system(s), physical component(s), and/or the like, that facilitates producing of any number of products, for example utilizing particular configurations that cause processing of particular inputs available within the process control and automation system 104. In some embodiments, the process control and automation system 104 includes one or more physical component(s), connection(s) between physical component(s), and/or computing system(s) that control operation of each physical component therein. Alternatively or additionally, in some embodiments the process control and automation system 104 includes one or more computing system(s) that are specially configured to operate the physical component(s) in a manner that produces one or more particular product(s) simultaneously. In some embodiments, process control and automation system 104 includes one or more computing device(s) and/or system(s) embodied in hardware, software, firmware, and/or a combination thereof, that configure and/or otherwise control operation of one or more physical component(s) in the processing plant. For example, in some embodiments, such computing device(s) and/or system(s) include one or more programmable logic controller(s), MPC(s), application server(s), centralized control system(s), and/or the like, that control(s) configuration and/or operation of at least one physical component. It will be appreciated that different process control and automation system 104 may include different physical component(s), computing system(s), and/or the like.

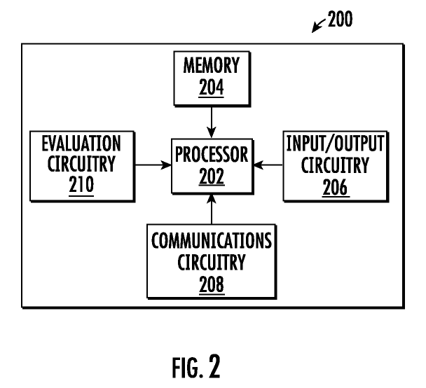

FIG. 1B illustrates a block diagram of an example industrial process control and automation system 104 in accordance with at least one example embodiment of the present disclosure. As shown in FIG. 2, the system 104 includes various components that facilitate production or processing of at least one product or other material. For instance, the system 104 can be used to facilitate control over components in one or more industrial plants. Each plant may represent one or more processing facilities (or one or more portions thereof), such as one or more manufacturing facilities for producing at least one product or other material. In general, each plant may implement one or more industrial processes and may, individually or collectively, be referred to as a process system. A process system generally represents any system or portion thereof configured to process one or more products or other materials.

In FIG. 1B, the system 104 includes one or more sensors 102a and one or more actuators 102b. The sensors 102a and actuators 102b represent components in a process system that may perform any of a wide variety of functions. For example, the sensors 102a could measure a wide variety of characteristics in the process system, such as flow, pressure, or temperature. Also, the actuators 102b could alter a wide variety of characteristics in the process system, such as, for example, valve openings. Each of the sensors 102a includes any suitable structure for measuring one or more characteristics in a process system. Each of the actuators 102b includes any suitable structure for operating on or affecting one or more conditions in a process system.

At least one network 107 is coupled to the sensors 102a and actuators 102b. The network 107 facilitates interaction with the sensors 102a and actuators 102b. For example, the network 107 could transport measurement data from the sensors 102a and provide control signals to the actuators 102b. The network 107 could represent any suitable network or combination of networks. In an example embodiment, the communications network 107 includes an ethernet network, electrical signal network, pneumatic control signal network, and/or the like. In some embodiments, the network 107 may include, without limitation, a wired or wireless Personal Area Network (PAN), Local Area Network (LAN), Metropolitan Area Network (MAN), Wide Area Network (WAN), and/or the like.

The system 104 includes various controllers 106. The controllers 106 may be used in the system 104 to perform various functions in order to control one or more industrial processes. For example, a first set of controllers 106 may user measurements from one or more sensors 102a to control the operations of one or more actuators 102b. A second set of controllers 106 may be used to optimize the control logic or other operations performed by the first set of controllers. A third set of controllers 106 could be used to perform additional functions. Each controller 106 includes any suitable structure for controlling one or more aspects of an industrial process. At least some of the controller 106 may, for example, represent proportional-integral-derivative (PID) controllers or multivariable controllers, such as controllers implementing model predictive control (MPC) or other advanced predictive control (APC). In an example embodiment, each controller 106 may represent a computing device running a real-time operating system, a WINDOWS operating system, or the like.

Operator access to and interaction with the controllers 106 and other components of the system 104 may occur via one or more operator consoles 110. An operator console 110 may comprise computing or communication devices. Each operator console 110 may be used to provide information to an operator and/or receive information from an operator. For example, each operator console 110 may provide information identifying a current state of industrial process to the operator, such as values of various process variables and warnings, alarms, or other states associated with the industrial process. Each operator console 110 may also receive information affecting how the industrial process is controlled, such as by receiving setpoints or control modes for process variables controlled by the controllers 106 or other information that alters or affects how the controllers 106 control the industrial process. Each operator console 110 includes any suitable structure for displaying information to and interacting with an operator. For example, each operator console 110 may represent a computing device running a WINDOWS operating system or other operating system.

Multiple operator consoles 110 may be grouped together and used in one or more control rooms 112. Each control room 112 may include any number of operator consoles 110 in any suitable arrangement. In some embodiments, multiple control rooms 112 may be used to control an industrial plant, such as when each control room 112 includes operator consoles 110 used to manage a discrete part of the industrial plant.

Each server 116 may comprise a computing device that executes applications for users of the operator consoles 110 or other applications. The applications may be used to support various functions for the operator consoles 110, the controllers 106, or other components of the system 104. Each server 116 may represent a computing device running a WINDOWS operating system or other operating system. It will be appreciated that while shown as being local within the system 104, the functionality of the server 116 may be remote from the system 104. For instance, the functionality of server 116 may be implemented in a computing cloud 118 or a remote server communicatively coupled to the system 104 (e.g., via a gateway 120 or the like)

The system 104 may include a repository 114 and/or one or more servers 116. The repository 114 may be configured to stored various information about the system 104. The repository 114, for example, may store information that is generated by the various controllers 106 during the control of one or more industrial processes. The repository 114 includes any suitable structure for storing and facilitating retrieval of information. Although illustrated as a single component in FIG. 1B, the repository 114 may be located elsewhere in the system 104, or multiple repositories may be distributed in different locations in the system 104.

In some embodiments, the controllers 106 may be associated with a hierarchical architecture, where a given controller is associated with a particular level in the hierarchical architecture. For example, in some embodiments, the system 104 may be implemented using a Purdue model of process control, where the controllers 106 may be associated with a hierarchical architecture/structure. In the Purdue model, “Level 0” may include the one or more sensors 102a and the one or more actuators 102b. In the Purdue model, “Level 1” may include one or more first-level controllers 106a configured to use the measurements from one or more sensors 102a to control the operations of one or more actuators 102b. For example, the one or more first-level controllers 106a may be configured to receive measurement data from one or more sensors 102a and use the measurement data to generate control signals for one or more actuators 102b. The first-level controllers 106a and the one or more sensors 102a and/or one or more actuators may be communicatively coupled via a via network.

In the Purdue model, “Level 2” may include one or more machine-level controllers 106b. The machine-level controllers 106b may perform various functions to support the operation and control of the first-level controllers 106a, sensors 102a, and actuators 102b, which could be associated with a particular piece of industrial equipment (such as a boiler or other machine). For example, the machine-level controllers 106b could log information collected or generated by the first-level controllers 106a, such as measurement data from the sensors 102a or control signals for the actuators 102b. The machine-level controllers 106b could also execute applications that control the operation of the first-level controllers 106a, thereby controlling the operation of the actuators 102b. Alternatively or additionally, the machine-level controllers 106b could provide secure access to the controllers 106b. The one or more machine-level controllers 106b may be communicatively coupled to the first-level controllers 106a, the sensors 102a, and/or the actuators 102b. Each of the machine-level controllers 106b includes any suitable structure for providing access to, control of, or operations related to a machine or other individual piece of equipment. Each of the machine-level controllers 106b may, for example, represent a server computing device running an operating system. Although not shown, different machine-level controllers 106b may be used to control different pieces of equipment in a process system (where each piece of equipment is associated with one or more first-level controllers 106a, sensors 102a, and actuators 102b).

In the Purdue model, “Level 3” may include one or more unit-level controllers 106c. Each unit-level controller 106c is typically associated with a unit in a process system, which represents a collection of different machines operating together to implement at least part of a process. The unit-level controllers 106c may be configured to perform various functions to support the operation and control of components in the lower levels. For example, the unit-level controllers 106c may log information collected or generated by the components in the lower levels, execute applications that control the components in the lower levels, and provide secure access to the components in the lower levels. Each of the unit-level controllers 106c includes any suitable structure for providing access to, control of or operations related to one or more machines or other pieces of equipment in a process unit. Each of the unit-level controllers 106c may, for example, represent a server computing device running an operating system. Different unit-level controllers 106c may be used to control different units in a process system (where each unit is associated with one or more machine-level controllers 106b, first-level controllers 106a, sensors 102a, and/or actuators 102b).

In the Purdue model, “Level 4” may include one or more plant-level controllers 106d. Each plant-level controller 106d may be associated with one or more process plants, which may include one or more process units that implement the same, similar, or different processes. The plant-level controllers 106d perform various functions to support the operation and control of components in the lower levels. For example, the plant-level controllers 106d may be configured to execute one or more manufacturing execution system (MES) applications, scheduling applications, or other additional plant or process control applications. Each of the plant-level controllers 106d includes any suitable structure for providing access to, control of or operations related to one or more process units in a process plant. Each of the plant-level controllers 106d may, for example, represent a server computing device running a MICROSOFT WINDOWS operating system. Access to the plant-level controllers 106d may be provided by one or more operator consoles.

In the Purdue model, “Level 5” may include one or more enterprise-level controllers (not shown). Each enterprise-level controller may be configured to perform planning operations for multiple process plants and to control various aspects of the plants. The enterprise-level controllers may also perform various functions to support the operation and control of component in the plants. As particular examples, the enterprise-level controller may be configured to execute one or more order processing applications, enterprise resource planning (ERP) applications, advanced planning and scheduling (APS) applications, or any other or additional enterprise control applications. Each of the enterprise-level controllers may include any suitable structure for providing access to, control of, or operations related to control of one or more process plants. Each of the enterprise-level controllers may, for example, represent a server computing device running an operating system. As used herein, the term enterprise may refer to an organization having one or more process plants or other processing facilities to be managed. It would be appreciated that if a single process plant is to be managed, the functionality of the enterprise-level controller may be incorporated into a plant-level controller 106d. Access to the enterprise-level controllers may be provided by one or more operator consoles. As described above, the operator console may include any suitable structure for supporting user access and control of one or more components in the system 104.

Various levels of the Purdue model can include other components, such as one or more repositories. The repository(s) associated with each level could store any suitable information associated with that level or one or more other levels of the system 104. A repository may, for example, store information used during production scheduling and optimization.

In some embodiments, the various controllers 106 and operator consoles in FIG. 1B may comprise computing devices. For example, each of the controllers 106 (106a-106e) may include one or more processing devices and/or one or more memories for storing instructions and data used, generated, or collected by the processing devices. Each of the controllers 106 may also include at least one network interface, such as one or more Ethernet interfaces or wireless transceivers. Also, each of the operator consoles may include at least one network interface, such as one or more Ethernet interfaces or wireless transceivers.

In some embodiments, at least one component of the system 104 may be configured to support a mechanism (e.g., a system, apparatus, or the like) for asset monitoring. For example, the functionality may be implemented in an operator console 110, a server, or a computing cloud 118 or a remote server. The functionality may be configured for monitoring APC assets (and/or other assets) to, for example, ensure maximum performance of the assets In some embodiments, an asset represents any hardware, software, or other physical or virtual component within a process control and automation system, or an underlying industrial process being controlled. An asset may be associated with a single industrial site (or a portion thereof), multiple industrial sites (or portions thereof), or an enterprise. An asset may include a controller 106 (e.g., 106a-106e). In an example embodiment, an asset describes a controller 106 (e.g., any of controllers 106a-106e).

FIG. 2 illustrates a block diagram of an example apparatus that may be specially configured in accordance with at least one example embodiment of the present disclosure. Specifically, FIG. 2 depicts an example asset monitoring apparatus 200 (“apparatus 200”) specially configured in accordance with at least some example embodiments of the present disclosure. In some embodiments, the asset evaluation system 103 and/or a portion thereof is embodied by one or more system(s), such as the apparatus 200 as depicted and described in FIG. 2. The apparatus 200 includes processor 202, memory 204, input/output circuitry 206, communications circuitry 208, and/or evaluation circuitry 210. In some embodiments, the apparatus 200 is configured, using one or more of the sets of circuitry embodied by processor 202, memory 204, input/output circuitry 206, communications circuitry 208, and/or evaluation circuitry 210, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s) , and/or other external computing device in communication with the apparatus 200.

In some embodiments, the apparatus 200 includes an evaluation circuitry 210. The evaluation circuitry 210 includes hardware, software, firmware, and/or a combination thereof, that supports generation of asset performance predictions in process control and automation systems, such as systems utilizing APC and/or PWO for monitoring and/or controlling processes associated with an industrial plant. The process control and automation system may generate process data associated the APC and/or PWO with respect to one or more processes being monitored and/or controlled using the APC and/or PWO. In some embodiments, the evaluation circuitry 210 includes hardware, software, firmware, and/or a combination thereof, that receive process data associated with a plant operation and identifies one or more excluded portions of the process data. The one or more excluded portions may comprise portions of the process data associated with one or more of controller maintenance mode condition, controller off mode condition, one or more asset variable maintenance mode conditions, or one or more asset variable off mode conditions.

In some embodiments, a controller maintenance mode condition describes a state and/or duration where the controller is not required (e.g., a not required duration associated with a controller) with respect to the current operation of the process being monitored and/or controlled by the APC or PWO. For example, a controller maintenance mode condition may be associated with a planned downtime with respect to the controller. For example, the controller may be taking off-line for maintenance or otherwise intended not to be utilized to monitor and/or control the associated process(es) for a particular duration (e.g., the duration of the controller maintenance mode condition). As one example, the controller maintenance mode condition may correspond to a planned downtime with respect to the controller. In some embodiments, a controller maintenance mode condition may be defined by a user. In some embodiments, the controller maintenance mode condition may be associated with one or more user-defined models leveraged by the evaluation circuitry 210 to determine when the process data (or portion(s)) thereof is associated with a controller maintenance mode condition.

In some embodiments, a controller off mode condition describes a state and/or duration where the controller is off with respect to the current operation of the process being monitored and/or controlled by the APC or PWO. In some embodiments, the controller off mode condition may describe a duration where the controller is turned off. For example, in some embodiments, the controller off mode condition may describe a duration where the controller is intended to be utilized for monitoring and/or controlling the process but is turned off (e.g., by an operator, or the like and/or for any of a variety of reasons). The controller off mode condition, for example, may correspond to an unplanned downtime or planned downtime with respect to the controller.

In some embodiments, the one or more asset variable maintenance mode conditions comprise a control variable (CV) off condition, a manipulated variable (MV) off condition, or a disturbance variable (DV) off condition. In some embodiments, an asset variable maintenance mode condition describes a state and/or duration where the asset variable (e.g., CV, MV, DV, or the like) is not required (e.g., a not required duration associated with asset variable) with respect to the current operation of the process being monitored and/or controlled by the APC or PWO. For example, an asset variable maintenance mode condition may be associated with a planned downtime with respect to the asset variable. For example, the asset variable may be taking off-line for maintenance or otherwise intended not to be utilized to monitor and/or control the associated process(es) for a particular duration (e.g., the duration of the asset variable maintenance mode condition). In some embodiments, an asset variable maintenance mode condition may be defined by a user. In some embodiments, the asset variable maintenance mode condition may be associated with one or more user-defined models leveraged by the evaluation circuitry 210 to determine when the process data (or portion(s)) thereof is associated with an asset variable maintenance mode condition.

In some embodiments, the one or more asset variable off mode conditions comprise a control variable (CV) off condition, a manipulated variable (MV) off condition, or a disturbance variable (DV) off condition. In some embodiments, an asset variable off mode condition describes a state and/or duration where the asset variable is off with respect to the current operation of the process being monitored and/or controlled by the APC or PWO. In some embodiments, the asset variable off mode condition may describe a duration where the asset variable is intended/planned to be utilized for monitoring and/or controlling the process but is turned off (e.g., by an operator, or the like and/or for any of a variety of reasons). As one example, the asset variable off mode condition may correspond to an unplanned downtime with respect to the asset variable.

In some embodiments, the evaluation circuitry 210 includes hardware, software, firmware, and/or a combination thereof, that removes from the process data, the one or more excluded portions such that one or more subsets of the process data remains for each of one or more process data evaluation iterations (as described further below). In this regard, the evaluation circuitry 210 may be configured to generate a process data subset by removing the one or more excluded portions from the process data. In some embodiments, the evaluation circuitry 210 includes hardware, software, firmware, and/or a combination thereof, that generates one or more asset performance scores (e.g., corresponding to APC controller KPIs and/or PWO KPIs) based on the one or more process data subsets. In some embodiments, the evaluation circuitry 210 includes hardware, software, firmware, and/or a combination thereof, that causes rendering of a user interface comprising the one or more asset performance scores. In some embodiments, the evaluation circuitry 210 includes a separate processor, specially configured field programmable gate array (FPGA), or a specially programmed application specific integrated circuit (ASIC).

Alternatively or additionally or in some embodiments, one or more of the sets of circuitries embodying processor 202, memory 204, input/output circuitry 206, communications circuitry 208, and/or evaluation circuitry 210. perform some or all of the functionality described as associated with another component. For example, in some embodiments, two or more of the sets of circuitry embodied by processor 202, memory 204, input/output circuitry 206, communications circuitry 208, and/or evaluation circuitry 210, are combined into a single module embodied in hardware, software, firmware, and/or a combination thereof. Similarly, in some embodiments, one or more of the sets of circuitry, for example evaluation circuitry 210, is/are combined with the processor 202, such that the processor 202 performs one or more of the operations described above with respect to each of these sets of circuitry embodied by the evaluation circuitry 210.

### EXAMPLE SYSTEM OPERATIONS

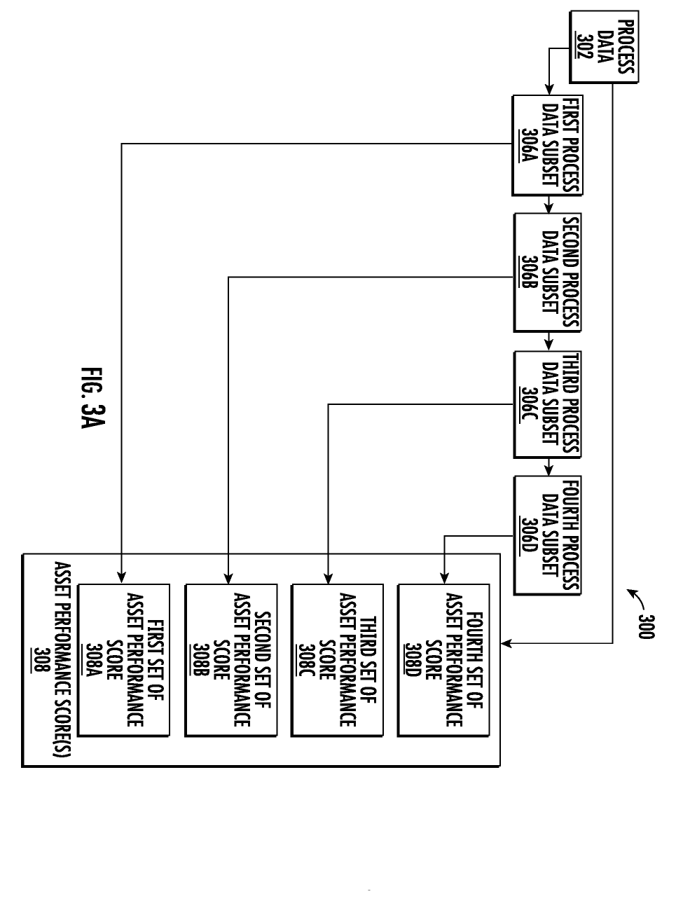

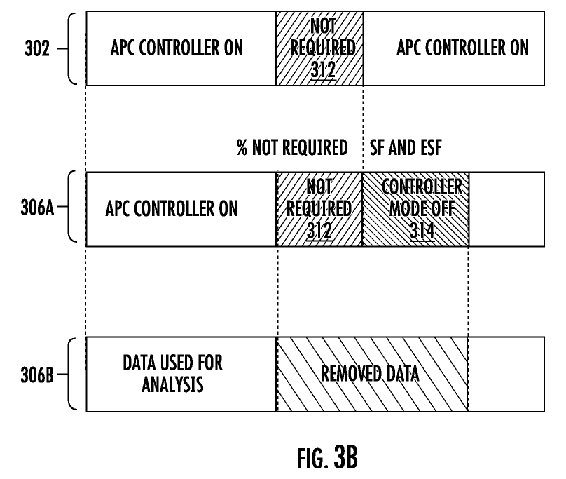

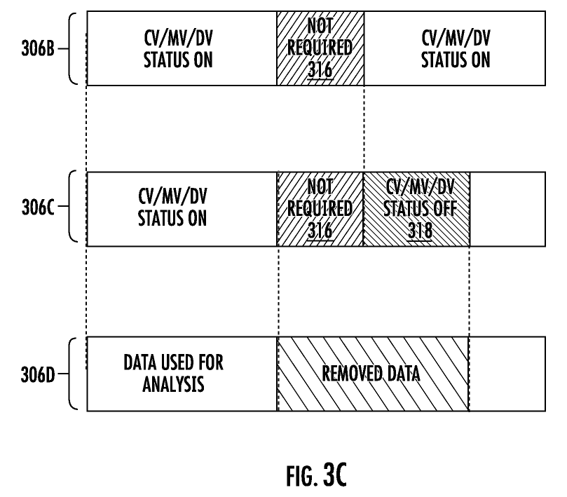

FIG. 3A is a dataflow diagram 300 showing example data structures for process monitoring, in accordance with at least some example embodiments of the present disclosure.

In some embodiments, process data 302 is received. The process data 302 may be associated with a plant operation (e.g., one or more process of the plant) being monitored and/or control using an APC and/or PWO is received. In this regard, the process data 302 may be associated with an APC controller and/or PWO. Additionally, the process data 302 may be associated with one or more asset variables of the APC controller or PWO. In some embodiments, the process data comprises a plurality of data samples. In some embodiments, the process data 302 may be received in real-time or near real-time from a process control and automation system, such as process control and automation system 104. For example, the process control and automation system may embody or otherwise comprise the APC and/or PWO. The APC and/or PWO may comprise one or more APC controllers, which APC controllers may be associated with one or more asset variables (e.g., CV, MV, DV, and/or the like). The APC and/or PWO, for example, may be configured to monitor process(es) of an industrial plant and/or control one or more operating parameters associated with the monitored process(es).

In some embodiments, one or more excluded portions of the process data 302 is identified and extracted (e.g., removed) from the process data to generate one or more process data subsets 306 (e.g., 306A-C). In some embodiments, the one more excluded portions comprises portions of the process data that if included in calculating certain KPIs for the APC controller or PWO would impact the accuracy of the KPIs, such that the calculated KPIs may not be accurate for the particular KPI. In some embodiments, the one or more excluded portions comprise portion(s) of the process data 302 associated with one or more of controller maintenance mode condition, controller off mode condition, or one or more asset variable off mode conditions. In some embodiments, a controller maintenance mode condition describes a state where the controller is not required. In some embodiments, a controller off mode condition describes a state where the controller is off. In some embodiments, the one or more asset variable off mode conditions comprise a control variable off condition, a manipulated variable off condition, or a disturbance variable off condition.

In some embodiments one or more process data evaluation iterations are performed to identify and extract excluded portions. For example, each iteration may comprise evaluating the process data 302 with respect to a particular condition to determine if the process data is associated with the particular condition. In some embodiments, the one or more process data evaluation iterations comprises a set of one or more controller-level process data evaluation iterations. In some embodiments, the set of one or more controller-level process data evaluation iterations comprise a first controller-level process data evaluation iteration performed based on the controller maintenance mode condition and second controller-level process data evaluation iteration performed based on the controller off mode condition. In some embodiments, alternatively or additionally, the one or more process data evaluation iterations comprises a set of one or more variable-level process data evaluation iterations. In some embodiments, the set of one or more variable-level process data evaluation iterations comprise a first variable-level process data evaluation iteration performed based on the one or more asset variable maintenance mode condition and second variable-level process data evaluation iteration performed based on the one or more asset variable off modes. In some embodiments, the set of one or more controller-level process data evaluation iterations and the set of one or more variable-level process data evaluation iterations are independent of each other. In some embodiments, the set of one or more variable-level process data evaluation iterations is associated with the set of one or more controller-level process data evaluation iterations. For example, in such some embodiments, the set of one or more variable-level process data evaluation iterations may utilize output of the set of one or more controller-level process data evaluation iterations.

In some embodiments, portion(s) of the process data 302 associated with a controller maintenance mode condition is identified and removed from the process data 302, such that a first process data subset 306A remains. For example, the first process data subset 306A may be generated by extracting (e.g., removing) data associated with a controller maintenance mode condition from the process data 302. In this regard, in some embodiments, a first process data evaluation iteration (e.g., a first controller-level process data evaluation iteration) may be performed and may comprise identifying and removing portions of the process data 302 associated with a controller maintenance mode condition. In some embodiments, performing the first controller-level process data evaluation iteration comprises, for each data sample associated with the process data, determining whether the data sample is associated with a controller maintenance mode condition based on one or more user-defined models and in response to determining that the process data is associated with a controller maintenance mode condition, removing the data sample from the process data.

In some embodiments, portion(s) of the first process data subset 306A associated with a controller off mode condition is identified and removed from the first process data subset 306A, such that a second process data subset 306B remains. For example, the second process data subset 306B may be generated by extracting (e.g., removing) data associated with a controller off mode condition from the first process data subset 306A. In this regard, in some embodiments, a second process data evaluation iteration (e.g., second controller-level process data evaluation iteration) may be performed and may comprise identifying and removing portions of the first process data subset 306A associated with a controller maintenance mode condition. In some embodiments, performing the second controller-level process data evaluation iteration comprises, for each data sample associated with the first process data subset, determining whether the data sample is associated with a controller off mode condition and in response to determining that the first process data subset is associated with a controller off mode condition, removing the data sample from the first process data subset.

In some embodiments, portion(s) of the second process data subset 306B associated with one or more asset variable maintenance mode conditions is identified and removed from the second process data subset 306B, such that a third process data subset 306C remains. For example, the third process data subset 306C may be generated by extracting (e.g., removing) data associated with one or more asset variable maintenance mode conditions from the second process data subset 306B. In some embodiments, the one or more asset variable maintenance mode conditions comprise any of a control variable (CV) maintenance mode condition, a manipulated variable (MV) maintenance mode condition, or a disturbance variable (DV) maintenance mode condition. In this regard, in some embodiments, a third process data evaluation iteration (e.g., first variable-level process data evaluation iteration) may be performed and may comprise identifying and removing portions of the second process data subset 306B associated with one or more asset variable maintenance mode conditions. In some embodiments, performing the first variable-level process data evaluation iteration comprises, for each data sample associated with the second process data subset, determining whether the data sample is associated with an asset variable maintenance mode condition and in response to determining that the second process data subset is associated with an asset variable maintenance mode condition, removing the data sample from the second process data subset.

In some embodiments, portion(s) of the third process data subset 306C associated with one or more asset variable off mode conditions is identified and removed from the third process data subset 306C, such that a fourth process data subset 306D remains. For example, the fourth process data subset 306D may be generated by extracting (e.g., removing) data associated with one or more asset variable off mode conditions from the third process data subset 306C. In some embodiments, the one or more asset variable off mode conditions comprise any of a control variable (CV) off condition, a manipulated variable (MV) off condition, or a disturbance variable (DV) off condition. In this regard, in some embodiments, a fourth process data evaluation iteration (e.g., second variable-level process data evaluation) may be performed and may comprise identifying and removing portions of the third process data subset 306C associated with one or more asset variable off mode conditions. In some embodiments, performing the second variable-level process data evaluation iteration comprises for each data sample associated with the third process data subset, determining whether the data sample is associated with an asset variable off mode condition and in response to determining that the fourth process data subset is associated with an asset variable off mode condition, removing the data sample from the third process data subset. It would be appreciated that in some embodiments, the process data evaluation iterations may not be performed in the other described above. For example, in some embodiments, the third and fourth iterations (e.g., the first and second variable-level process data evaluation iterations) may be performed independent of and/or simultaneously with the first and second iterations (e.g. the first second controller-level process data evaluation iterations).

FIG. 3B illustrates a visualization of process data evaluation iterations at a controller level in accordance with at least one example embodiment of the present disclosure. Specifically, FIG. 3B illustrates a visualization of a set of one or more controller-level process data evaluation iterations in accordance with at least one example. As shown in FIG. 3B, a first portion 312 of the process data 302 may be associated with a controller maintenance mode condition (e.g., “not required”). According to various embodiments, the first portion 312 is identified and removed from the process data 302 such that a first process data subset 306A remains. In some embodiments, a percent-not-required score (e.g., corresponding to a percent-not-required KPI for the controller) is generated based at least in part on the first process data subset 306A. In some embodiments, the percent-not-required score is generated at least in part by comparing a number of data samples removed from the process data (e.g., remaining data samples) to the number of data samples associated with the process data. For example, a percentage of the data samples removed (from the process data 302) with respect to the initial data samples may be calculated. According to various embodiments, the percent-not-required score (e.g., corresponding to a percent-not-required KPI for the APC/PWO controller, CV, MV, or DV) describes the duration with respect to which the controller was associated with a controller maintenance mode condition over the sampling period.

As shown in FIG. 3B, a second portion 314 of the first process data subset 306A may be associated with a controller off mode condition (e.g., “controller mode off”). According to various embodiments, the second portion 314 is identified and removed from the first process data subset 306A such that a second process data subset 306B remains. In some embodiments, a service factor score corresponding to a service factor KPI for the controller is generated. In some embodiments, the service factor score is generated at least in part by comparing a number of data samples removed from the first process data subset 306A to the number of data samples associated with the first process data subset. For example, a percentage of the data samples removed (from the first process data subset 306A) with respect to the first process data subset 306A may be calculated. According to various embodiments, the service factor score (e.g., corresponding to a service factor KPI for the controller) describes the duration with respect to which the controller was associated with a controller maintenance mode condition over the portion of the sampling period that does not include controller maintenance mode condition. Alternatively or additionally, in some embodiments, an effective service factor score corresponding to an effective service factor KPI for the controller is generated. In some embodiments, the effective service factor score is generated at least in part by comparing a number of data samples removed from the first process data subset 306A to the number of data samples associated with the first process data subset 306A. For example, a percentage of the data samples removed (from the first process data subset 306A) with respect to the first process data subset 306A may be calculated. According to various embodiments, the effective service factor score (e.g., corresponding to an effective service factor KPI for the controller) describes the duration with respect to which the controller was associated with a controller maintenance mode condition over the portion of the sampling period that does not include controller maintenance mode condition.

In some embodiments, one or more asset performance scores corresponding to other KPIs for the controller is generated using the second process data subset 306B. Non-limiting examples of such asset performance scores that can be generated using the second process data subset 306B include limit violation KPI, limit tracking KPI, and/or the like.

FIG. 3C illustrates a visualization of process data evaluation iterations at a variable level in accordance with at least one example embodiment of the present disclosure. Specifically, FIG. 3B illustrates a visualization of a set of one or more asset variable-level process data evaluation iterations in accordance with at least one example. As shown in FIG. 3C, a third portion 316 of the second process data subset 306B may be associated with one or more asset variable maintenance mode conditions. According to various embodiments, the third portion 316 is identified and removed from the second process data subset 306B such that a third process data subset 306C remains.

In some embodiments, a percent-not-required score (e.g., corresponding to a percent-not-required KPI for the controller and/or a particular asset variable) is generated based at least in part on the second process data subset 306B. In some embodiments, the percent-not-required score is generated at least in part by comparing a number of data samples removed from the second process data subset 306B (e.g., remaining data samples) to the number of data samples associated with the second process data subset 306B. For example, a percentage of the data samples removed (from the second process data subset 306B) with respect to the data samples associated with the second process data subset 306B may be calculated.

As shown in FIG. 3B, a fourth portion 318 of the third process data subset 306C may be associated with one or more asset variable off mode conditions. According to various embodiments, the fourth portion 318 is identified and removed from the third process data subset 306C such that a fourth process data subset 306D remains.

In some embodiments, a service factor score corresponding to a service factor KPI for the controller and/or a particular asset variable is generated. In some embodiments, the service factor score is generated at least in part by comparing a number of data samples removed from the third process data subset 306C to the number of data samples associated with the third process data subset 306C. For example, a percentage of the data samples removed (from the third process data subset 306C) with respect to the third process data subset 306C may be calculated.

Alternatively or additionally, in some embodiments, an effective service factor score corresponding to a service factor KPI for the controller and/or a particular asset variable is generated. In some embodiments, the effective service factor score is generated at least in part by comparing a number of data samples removed from the third process data subset 306C to the number of data samples associated with the third process data subset 306C. For example, a percentage of the data samples removed (from the third process data subset 306C) with respect to the third process data subset 306C may be calculated. In some embodiments, at the controller level, the KPI’s may comprise roll up of KPI’s from different asset variables (e.g., CV, MV, DV) of the APC/PWO.

In some embodiments, one or more asset performance scores corresponding to other KPIs for the controller is generated using the fourth process data subset 306D. Non-limiting examples of such asset performance scores that can be generated using the fourth process data subset 306D include limit violation KPI, limit tracking KPI, and/or the like.

In this regard, in some embodiments, one or more asset performance scores 308 (e.g., 308A-C) may be generated based on the process data 302 and/or one or more process data subsets 306 (e.g., first process data subset 306A, second process data subset 306B, third process data subset 306C, and/or fourth process data subset 306D). As described above, in some embodiments, a set of one or more asset performance scores 308A may be generated based on the process data and/or first process data subset 306A. In some embodiments, a set of one or more asset performance scores 308B may be generated based on the process data and/or a second process data subset 306B. In some embodiments, a set of one or more asset performance scores 308C may be generated based on the process data and/or a third process data subset 306C. In some embodiments, a set of one or more asset performance scores 308D may be generated based on the process data and/or a third process data subset 306C.

In this regard, as illustrated in FIGS. 3A-3C, one or more KPIs may be calculated based on the process data or a process data subset of the one or more process data subsets. By way of non-limiting example and for illustration, if 20% of the process data comprises data associated with a controller maintenance mode condition (e.g., not required duration of APC/PWO controller), the portion of the process data corresponding to the 20% controller maintenance mode condition may be removed leaving 80% of the process data as the remaining data. Percent-not-required KPI may calculated to be 20% and the remaining 80% of the process data may be used to calculate one or more other KPIs. For example, for such one or more other KPIs the remaining 80% of the process data may be considered as 100% for calculating these one or more other KPIs. For example, if 15% of the 80% remaining data (e.g., considered 100% data for one or more KPI calculations) comprises data associated with an asset variable off mode condition such as a CV off mode condition, for example, the CV service factor may be calculated as 85% and the CV effective service factor calculated as 65% (e.g., based on 15% of the remaining 80% process data being associated with the CV off mode condition and 20% of the process data related to MV being saturated). Continuing with the illustration, the 15% of the 80% remaining data that is associated with the CV off mode condition may be removed and the remaining data considered as 100% data for one or more other KPIs (e.g., model quality, limit activation, OSI, RPI, and/or or the like).

In some embodiments, a user interface comprising the one or more asset performance scores 308 (or a portion thereof) is caused to be rendered on a user device and/or a dashboard.

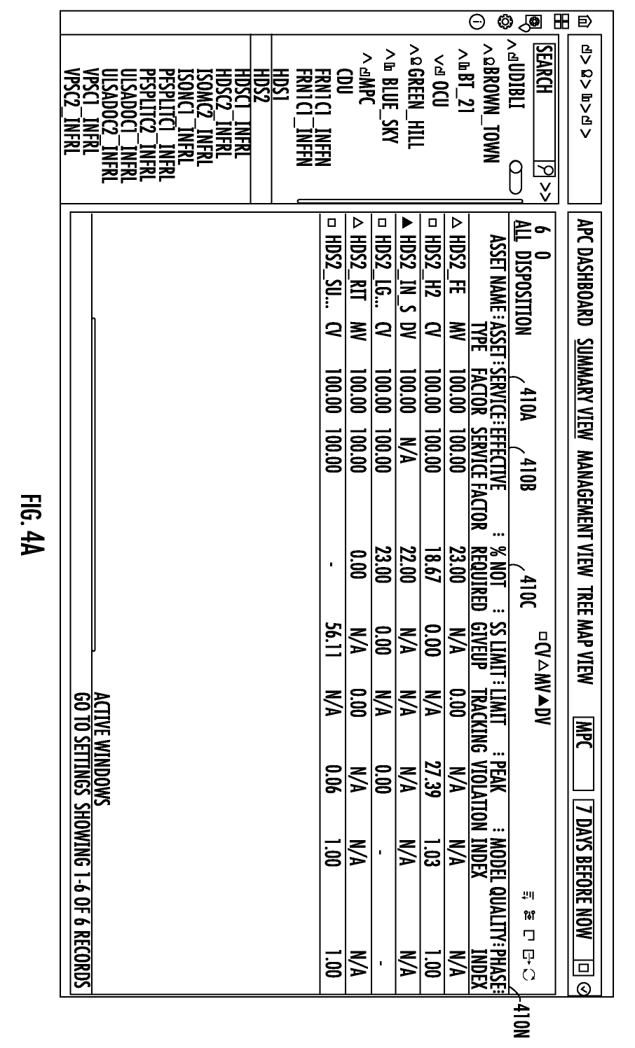

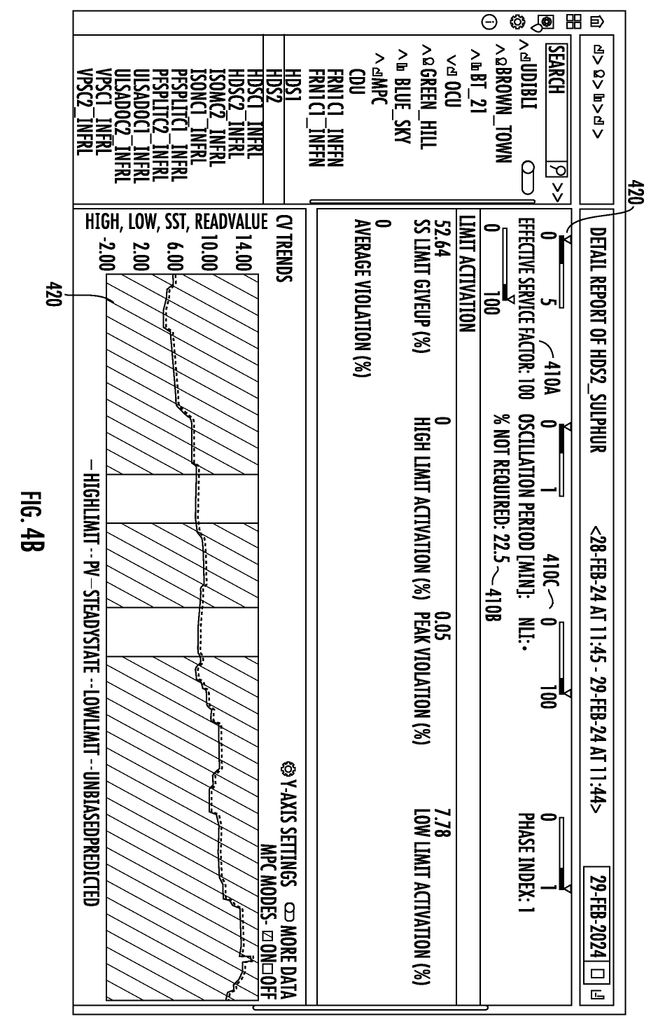

FIGS. 4A-B show example user interfaces 400 comprising a visualization of one or more asset performance scores 410A-N for an asset (e.g., a controller, CV, MV, DV, or the like) in accordance with at least one example embodiment of the present disclosure. As shown in FIG. 4A, the example user interface 400 may display a service factor score 410A, an effective service factor score 410B, a percent-not-required score 410C, and/or the like. In some embodiments, the user interface 400 may comprise a representation 420 (e.g. graphical representation, bar representation, trend chart or the like) of the one or more asset performance scores 410A-N.

### EXAMPLE PROCESSES OF THE DISCLOSURE

Having described example systems and apparatuses, data visualizations, and formulas in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

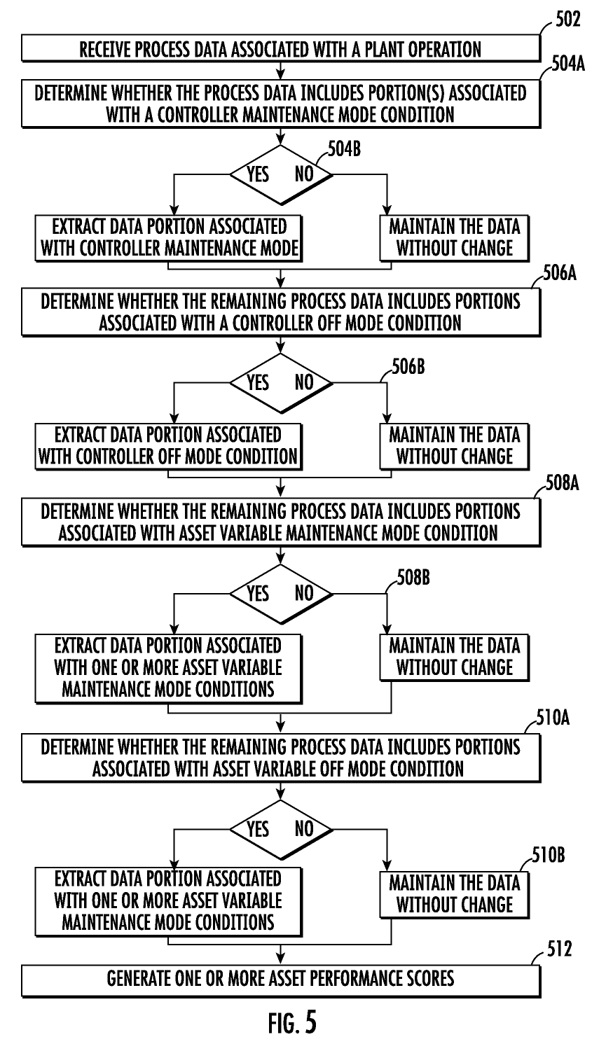

FIG. 5 illustrates flowchart including operations of an example process for asset performance predictions in accordance with at least one example embodiment of the present disclosure Specifically, FIG. 5 depicts an example process 500 for improved process monitoring. In some embodiments, the process 500 is embodied by computer program code stored on a non-transitory computer-readable storage medium of a computer program product configured for execution to perform the process as depicted and described. Alternatively or additionally, in some embodiments, the process 1000 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process 1000 is described as performed by and from the perspective of the apparatus 200.

Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 1000 may perform functions at substantially the same time or in a specific sequence.

According to some examples, the method includes at operation 502, receiving process data associated with a plant operation.

According to some examples, the method includes at operation 504A determining whether the process data includes portion(s) associated with a controller maintenance mode condition. According to some examples, the method includes at operation 504B, in response to determining that the process data includes portion(s) associated a controller maintenance mode, extracting the portion(s) of the process data associated with a controller maintenance mode condition, such that a first process data subset remains. For example, apparatus 200, in response to determining that the process data is associated with a controller maintenance mode condition, may generate a first process data subset by extracting data associated with controller maintenance mode condition from the process data, wherein the first process data subset represents the remaining data after operation 504 (e.g., 504A-B). In response to determining that the process data does not include any portion associated with a controller maintenance mode, the apparatus 200 may not extract any portions of the process data, such that the process data as received represents the remaining process data after operation 504 (e.g., 504A-B).

According to some examples, the method includes at operation 506A determining whether the remaining process data (e.g., which may be the first subset process data or unmodified process data) includes portion(s) associated with a controller off mode condition. According to some examples, the method includes at operation 506B, in response to determining that the remaining process data includes portion(s) associated a controller off mode condition, the apparatus 200 extracts the portion(s) of the process data associated with a controller off mode condition, such that a second process data subset remains. For example, apparatus 200, in response to determining that the remaining data is associated with a controller maintenance off mode condition, may generate a second process data subset by extracting data associated with controller off mode condition from the remaining process data, wherein the second process data subset becomes the remaining process data. In response to determining that the remaining data does not include any portion associated with a controller maintenance mode, the apparatus 200 may not extract any portions of the remaining process data.

According to some examples, the method includes at operation 508A determining whether the remaining process data includes portion(s) associated with one or more asset variable maintenance mode conditions. According to some examples, the method includes at operation 508B, in response to determining that the remaining process data includes portion(s) associated a one or more asset variable maintenance mode conditions, the apparatus 200 extracts the portion(s) of the process data associated with one or more asset variable maintenance mode conditions, such that a third process data subset remains. For example, apparatus 200, in response to determining that the remaining data is associated with a one or more asset variable maintenance mode conditions, may generate a third process data subset by extracting data associated with one or more asset variable maintenance mode conditions from the remaining process data. In response to determining that the remaining data does not include any portion associated with an asset maintenance mode conditions, the apparatus 200 may not extract any portions of the remaining data.

According to some examples, the method includes at operation 510A determining whether the remaining process data includes portion(s) associated with one or more asset variable off mode conditions. According to some examples, the method includes at operation 510B, in response to determining that the remaining process data includes portion(s) associated a one or more asset variable off mode conditions, the apparatus 200 extracts the portion(s) of the process data associated with one or more asset variable off mode conditions, such that a fourth process data subset remains. For example, apparatus 200, in response to determining that the remaining data is associated with a one or more asset variable off mode conditions, may generate a fourth process data subset by extracting data associated with one or more asset variable off mode conditions from the remaining process data. In response to determining that the remaining data does not include any portion associated with a controller maintenance mode, the apparatus 200 may not extract any portions of the remaining data.

According to some examples, the method includes at operation 512, is generating one or more one or more process data subsets. In some embodiments, one or more asset performance scores is generated based on the one or more process data subsets. In some embodiments, a first set of asset performance scores 308A is generated based on the first process data subset. In some embodiments, a second set of asset performance scores is generated based on the second process data subset. In some embodiments, the first of one or more asset performance scores comprises at least one or a service factor score or an effective service factor score. In some embodiments, a third set of asset performance scores is generated based on the third process data subset. In some embodiments, a fourth set of asset performance scores is generated based on the fourth process data subset.

In some embodiments, a user interface comprising the one or more asset performance scores is caused to be rendered on a suer device and/or a dashboard.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by one or more processors, process data associated with a controller, the process data comprising a plurality of data samples;
performing, by the one or more processors, one or more process data evaluation iterations to generate one or more process data subsets by removing one or more portions of the process data that is associated with at least one asset condition of one or more asset conditions;
generating, by the one or more processors and based on the one or more process data subsets, one or more asset performance scores; and
causing, by the one or more processors, rendering of a user interface comprising the one or more asset performance scores on a user device.

2. The computer-implemented method of claim 1, wherein the one or more asset conditions comprise a controller maintenance mode condition associated with the controller and a controller off mode condition associated with the controller.

3. The computer-implemented method of claim 2, wherein the one or more process data evaluation iterations comprises a set of one or more controller-level process data evaluation iterations, where the set of one or more controller-level process data evaluation iterations comprise (i) a first controller-level process data evaluation iteration performed based on the controller maintenance mode condition and (ii) second controller-level process data evaluation iteration performed based on the controller off mode condition.

4. The computer-implemented method of claim 3, wherein the one or more process data subsets comprises a first process data subset that is generated by performing the first controller-level process data evaluation iteration, wherein performing the first controller-level process data evaluation iteration comprises:
for each data sample associated with the process data:
determining whether the data sample is associated with a controller maintenance mode condition based on one or more user-defined models; and
in response to determining that the process data is associated with a controller maintenance mode condition, removing the data sample from the process data.

5. The computer-implemented method of claim 4, wherein the one or more asset performance scores comprises a percent-not-required score corresponding to a percent-not-required KPI for the controller, wherein the percent-not-required score is generated at least in part by comparing a number of data samples removed from the process data to the number of data samples associated with the process data.

6. The computer-implemented method of claim 4, wherein the one or more process data subsets comprises a second process data subset that is generated by performing the second controller-level process data evaluation iteration of the set of one or more controller-level process data evaluation iterations, wherein performing the second controller-level process data evaluation iteration comprises:
for each data sample associated with the first process data subset:
determining whether the data sample is associated with a controller off mode condition; and
in response to determining that the first process data subset is associated with a controller off mode condition, removing the data sample from the first process data subset.

7. The computer-implemented method of claim 6, wherein the one or more asset performance scores comprises one or more of a service factor score corresponding to a service factor KPI for the controller or an effective service factor score corresponding to an effective service factor KPI for the controller, wherein the service factor score or the effective service factor score is generated at least in part by comparing a number of data samples removed from the first process data subset to the number of data samples associated with the first process data subset.

8. The computer-implemented method of claim 6, wherein the one or more asset conditions further comprise one or more asset variable maintenance mode conditions and one or more asset variable off mode conditions.

9. The computer-implemented method of claim 8, wherein the one or more process data evaluation iterations comprises a set of one or more variable-level process data evaluation iterations, where the set of one or more variable-level process data evaluation iterations comprise (ii) a first variable-level process data evaluation iteration performed based on the one or more asset variable maintenance mode conditions and (ii) second variable-level process data evaluation iteration performed based on the one or more asset variable off mode conditions.

10. The computer-implemented method of claim 9, wherein the one or more process data subsets comprises a third process data subset that is generated by performing the first variable-level process data evaluation iteration, wherein performing the first variable-level process data evaluation iteration comprises:
for each data sample associated with the second process data subset:
determining whether the data sample is associated with at least one of the one or more asset variable maintenance mode conditions; and
in response to determining that the second process data subset is associated with at least one of the one or more asset variable maintenance mode conditions, removing the data sample from the second process data subset.

11. The computer-implemented method of claim 10, wherein the one or more asset performance scores comprises a percent-not-required score corresponding to a percent-not-required KPI for the controller, wherein the percent-not-required score is generated by comparing a number of data samples associated with the third process data subset to the number of data samples associated with the second process data subset.

12. The computer-implemented method of claim 10, wherein the one or more process data subsets comprises a fourth process data subset that is generated by performing a second variable-level process data evaluation iteration of the set of one or more variable-level process data evaluation iterations, wherein performing the second variable-level process data evaluation iteration comprises:
for each data sample associated with the third process data subset:
determining whether the data sample is associated with at least one of the one or more asset variable off mode conditions; and
in response to determining that the fourth process data subset is associated with at least one of the one or more asset variable off mode conditions, removing the data sample from the third process data subset.

13. The computer-implemented method of claim 12, wherein the one or more asset performance scores comprises a service factor score corresponding to a service factor KPI for the controller, wherein the service factor score is generated by comparing a number of data samples associated with the fourth process data subset to the number of data samples associated with the third process data subset.

14. An apparatus comprising at least one processor and at least one memory storing instructions that, when executed by the at least one processor, cause the apparatus to:
receive process data associated with a controller, the process data comprising a plurality of data samples;
perform one or more process data evaluation iterations to generate one or more process data subsets by removing one or more portions of the process data that is associated with at least one asset condition of one or more asset conditions;
generate, based on the one or more process data subsets, one or more asset performance scores; and
cause rendering of a user interface comprising the one or more asset performance scores on a user device.

15. The apparatus of claim 14, wherein the one or more asset conditions comprise a controller maintenance mode condition associated with the controller and a controller off mode condition associated with the controller.

16. The apparatus of claim 15, wherein the one or more process data evaluation iterations comprises a set of one or more controller-level process data evaluation iterations, where the set of one or more controller-level process data evaluation iterations comprise (i) a first controller-level process data evaluation iteration performed based on the controller maintenance mode condition and (ii) second controller-level process data evaluation iteration performed based on the controller off mode condition.

17. The apparatus of claim 16, wherein the one or more process data subsets comprises a first process data subset that is generated by performing the first controller-level process data evaluation iteration, wherein performing the first controller-level process data evaluation iteration comprises:
for each data sample associated with the process data:
determining whether the data sample is associated with a controller maintenance mode condition based on one or more user-defined models; and
in response to determining that the process data is associated with a controller maintenance mode condition, removing the data sample from the process data.

18. The apparatus of claim 17, wherein the one or more asset performance scores comprises a percent-not-required score corresponding to a percent-not-required KPI for the controller, wherein the percent-not-required score is generated at least in part by comparing a number of data samples removed from the process data to the number of data samples associated with the process data.

19. The apparatus of claim 17, wherein the one or more process data subsets comprises a second process data subset that is generated by performing the second controller-level process data evaluation iteration of the set of one or more controller-level process data evaluation iterations, wherein performing the second controller-level process data evaluation iteration comprises:
for each data sample associated with the first process data subset:
determining whether the data sample is associated with a controller off mode condition; and
in response to determining that the first process data subset is associated with a controller off mode condition, removing the data sample from the first process data subset.

20. At least one non-transitory computer-readable storage medium having computer coded instructions configured to, when executed by at least one processor:
receive process data associated with a controller, the process data comprising a plurality of data samples;
perform one or more process data evaluation iterations to generate one or more process data subsets by removing one or more portions of the process data that is associated with at least one asset condition of one or more asset conditions;
generate, based on the one or more process data subsets, one or more asset performance scores; and
cause rendering of a user interface comprising the one or more asset performance scores on a user device.
